(19) United States
(12) Patent Application Publication
(10) Pub. No.: US 2015/0073613 A1
(43) Pub. Date: Mar. 12, 2015

(54) SMART CLOUD SERVICE POWER OUTLET WITH SURGE PROTECTION AND CLOUD SERVICE POWER CONSUMPTION MONITORING SYSTEM

(71) Applicants: MAX CHIN LI, New Taipei City (TW); YUNG-CHE FANG, New Taipei City (TW); ROY YUAN SHIK TING, New Taipei City (TW)

(72) Inventors: MAX CHIN LI, New Taipei City (TW); YUNG-CHE FANG, New Taipei City (TW); ROY YUAN SHIK TING, New Taipei City (TW)

(21) Appl. No.: 14/023,081

(22) Filed: Sep. 10, 2013

(51) Int. Cl. H04L 12/28; H02J 4/00

(52) U.S. Cl. CPC H04L 12/2816; H02J 4/00
USPC 700/295

(57) ABSTRACT

A smart cloud service power outlet with surge protection, establishes communication with a cloud service platform via a wide-area-network. The smart cloud service power outlet detects power consumption result, and connects the cloud service platform via a wireless bridging device, so as to download a power supplying schedule from the cloud service platform and stores the power supplying schedule in a storage unit and then upload the power consumption result to the cloud service platform to generate a power consumption log. The power supplying schedule includes power supplying plan for plural days, and the smart cloud service power outlet enables or disables power supply of a power supplying interface. Furthermore, the smart cloud service power outlet receives a bypass signal or an external signal to perform a switching action opposite to the current power supply status.

### BACKGROUND OF THE INVENTION

1. Field of the Invention

This disclosure relates to remote power consumption management, and more particularly to a smart cloud service power outlet with surge protection and a cloud service power consumption monitoring system.

2. Related Art

A smart power outlet enables and disables power supply according to a schedule. Meanwhile, the smart power outlet can be monitored and operated by a remote end, so that the remote end can generate a power consumption log. Usually, the aforementioned schedule only contains short term power management, for example a power management plan for one day, that is long term power management can not be done.

Commercial smart power outlets include simple smart power outlets which are directly sold to end user. However, when a remote end device attempts to access a smart power outlet via internet like the abovementioned smart power outlet, a correct IP address is required to establish connection. Management for considerable number of smart power outlets is difficult to execute with such a design. A data service platform is usually in absence, therefore a power consumption logging function is also in absence and graphic analysis chart is unable to be obtained. Generally, such kind of smart power outlet only contains remote control function, and lakes power consumption detecting function.

A smart power outlet for a green building is usually operated via a management platform of a service provider. The service of the management platform requires scheduled payment. The status of the smart power outlet is transmitted to the management platform. A user can use a smart phone or a PC to connect the management platform, so as to access require data and control the smart power outlet remotely.

The management platform is useful to monitor and control the smart power outlet. However, when the connection interrupted, the smart power outlet fails to update the latest power supply schedule and remote control function also fails. Moreover, the development of the smart power outlet focus on eco electricity, and the development of electrical safety awareness are usually neglected.

### SUMMARY OF THE INVENTION

In view of the insufficiency in power management and monitoring function of the smart power outlet in the prior art, this disclosure provide a smart cloud service power outlet with surge protection and a cloud service power consumption monitoring system to improve power management and monitoring function.

The smart cloud service power outlet with surge protection of this disclosure establishes communication with a cloud service platform via a wide-area-network (WAN). The smart cloud service power outlet includes a power supplying interface, a power consumption detector, a control system, a switch, and a bypass signal generator.

The power supplying interface connects to an external power source and is equipped with power output nodes.

The power consumption detector connects to the power supplying interface and the external power source, to detect power consumption of the power supplying interface and generate a power consumption result.

The control system includes a controller, a storage unit, and a wireless transceiver module. The controller connects to the power consumption detector to receive the power consumption result, so as to monitor the power usage status of the power supplying interface. The storage unit stores a power supplying schedule and the power consumption result. The controller enables or disables the power supply of the power supplying interface according to the power supplying schedule, wherein the power supplying schedule includes power supplying plan for plural days. The wireless transceiver module connects to a wireless bridging device through a local-area-network (LAN) protocol, so as to connect to a WAN. Then the wireless transceiver module establishes connection to the cloud service platform to download the power supplying schedule to the storage unit and upload power consumption result to the cloud service platform, so as to generate a power consumption log.

The switch is disposed between the power supplying interface and the external power source. And the switch connects to the controller to be controlled by the controller, wherein the controller controls the power supplying interface to break or recover the connection between the power supplying interface and the external power source, so as to enable or disable the power supply of the power supplying interface.

The bypass signal generator is triggered to generate a bypass signal; when the controller receives the bypass signal, the bypass signal override the current power supplying schedule and the controller perform a switching action opposite to the current power supply status.

In this disclosure, the power supplying schedule includes power supplying plan for plural days, for example power supplying plan for a week. When the network connection fails for long time, a complete power supplying schedule for long term can be well executed before network connection is recovered. Furthermore, through the bypass signal generator, the user can manually change the power supply status without restriction of the power supplying schedule.

This disclosure further provides cloud service power consumption monitoring system, which detects the presence of the smart cloud service power outlet via a presence server, so as to prevent unnecessary data package transmission between the cloud service platform and the cloud service power outlet. Therefore, the bandwidth speed of the cloud service platform is improved, and capacity of management of the cloud service platform is increased.

The present invention will become more obvious from the following description of the preferred embodiments taken in conjunction with the accompanying drawings.

### BRIEF DESCRIPTION OF THE DRAWINGS

The present invention will become more fully understood from the detailed description given herein below for illustration only, and thus not limitative of the present invention, wherein:

FIG. 1 is a block diagram of the smart cloud service power outlet with surge protection of this disclosure.

FIG. 2 is a schematic diagram showing the connection among the remote end device, the smart cloud service power outlet, the cloud service platform, and the presence server.

FIG. 3 is a schematic diagram showing the connection between the remote end device and the smart cloud service power outlet in LAN.

### DETAILED DESCRIPTION OF THE INVENTION

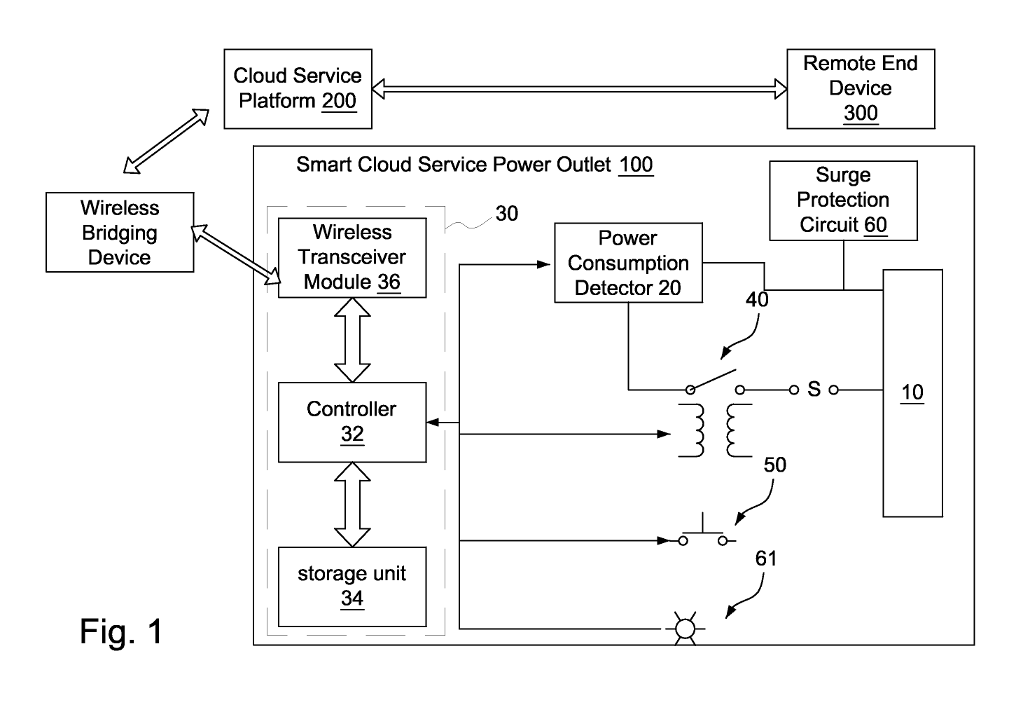

Please refer to FIG. 1, the smart cloud service power outlet 100 with surge protection of this disclosure includes a power supplying interface 10, a power consumption detector 20, a control system 30, a switch 40, a bypass signal generator 50, and a surge protection circuit 60.

Please refer to FIG. 1, the power supplying interface 10 connects to an external power source S and is equipped with power output nodes. The power supplying interface 10 can be but not limited to an outlet for household which is connected to an external AC power source and connected by a plug, so as to output power through the plug.

The power consumption detector 20 is connected to the power supplying interface 10 and the external power source, to construct a power supply and monitoring circuit loop. In this circuit loop, the power consumption detector 20 detects current or power consumed by the power supplying interface 10, and generates a power consumption result.

As shown in FIG. 1, the control system 30 includes a controller 32, a storage unit 34, and a wireless transceiver module 36.

The controller 32 connects to the power consumption detector 20 to receive the power consumption result, so as to monitor the power usage status of the power supplying interface 10.

The storage unit 34 stores programming codes, power supplying schedule, and so on. The storage unit 34 can be but not limited to a flash memory module, so as to store or update programming codes and power supplying schedule quickly, and keeps data when power of the flash memory module is cut off. The controller 32 enables or disables the power supply of the power supplying interface 10 according to the power supplying schedule. And the power supplying schedule includes power supplying plan for plural days.

The wireless transceiver module 36 connects to a wireless bridging device through a LAN protocol, so as to connect to a wide-area-network (WAN). Then the wireless transceiver module 36 establishes connection to the cloud service platform 200 via the WAN. The LAN protocol can be but not limited to Wi-Fi, Zigbee, or Bluetooth.

Please refer to FIG. 1; the switch 40 is disposed between the power supplying interface 10 and the external power source S. And the switch 40 connects to the controller 32 to be controlled by the controller 32. The controller 32 controls the power supplying interface 10 to break or recover the connection between the power supplying interface 10 and the external power source S. The switch 40 can be but not limited to a relay.

In detail, the controller 32 loads the power supplying schedule from the storage unit 34, and then the controller 32 drives the switch 40 to enables or disables the power supply of the power supplying interface 10 according to the power supplying schedule. Through connecting to the cloud service platform 200 with the wireless transceiver module 36, the smart cloud service power outlet 100 downloads power supplying schedule from the cloud service platform 200 to the storage unit. According to the power supplying schedule, the controller 32 drives the switch 40 to enables or disables the power supply of the power supplying interface 10. The power supplying schedule includes power supplying plan for plural days, therefore connection interrupted between the smart cloud service power outlet 100 and the cloud service platform 200 for days will not affect the switching of power supply.

The smart cloud service power outlet 10 uploads the power consumption result to the cloud service platform via the WAN, so as to generate a power consumption log. When the remote end device 300 connects to the cloud service platform 200, the remote end device 300 can access the current power consumption result and power consumption log, so as to analysis the power output of the power supplying interface 10 as a reference for eco electricity management.

Furthermore, the controller 32 can continuously monitors power loading of the power supplying interface through the power consumption detector 20. When the power loading of the power supplying interface 10 higher than a power loading threshold, the controller 32 drives the switch 40 to disables the power supply of the power supplying interface 10. Meanwhile, the controller 32 uploads the overloading event that the power loading is higher than the power loading threshold to the cloud service platform 20 by the wireless transceiver module 36. The cloud service platform 200 can send the overloading event to a designated e-mail address through e-mail; or through application installed in the remote end device 300, the cloud service platform 200 establishes peer-to-peer communication, and pushes the overloading event to the remote end device 300.

The power supplying interface 10 can connect to a leakage current detecting circuit 70 having a grounding line, for example a resistor having high resistance connected to a current detector, and detect current leakage through the power supplying interface 70. When the controller 32 obtains leakage event through the leakage current detecting circuit 70, the controller 32 drives the switch to disables the power supply of the power supplying interface 10, to prevent the user from electric shock. Similar, the leakage is also transmitted to the cloud service platform 200. The cloud service platform 200 can send the leakage event to a designated e-mail address through e-mail; or through application installed in the remote end device 300, the cloud service platform 200 establishes peer-to-peer communication, and pushes the leakage event to the remote end device 300.

Moreover, the controlling policy of the controller 32 is that the external control signal overrides the power supplying schedule. The external signal can be a switch signal received through the wireless transceiver module or a bypass signal generated by the bypass signal generator 50.

The controller 32 connects to the cloud service platform 200 via the wireless transceiver module 36, and the controller 32 sends a device ID to the cloud service platform 200 for the cloud service platform 200 to identify the smart cloud service power outlet 100. The remote end device 300 can be a smart phone or a PC. The remote end device 300 connects to the cloud service platform 200 via the WAN. Through the device ID or other identification mechanism related to the device ID, the remote end device 300 requests and accesses the current power consumption result and the power consumption history. The remote end device 300 can also issue an enabling signal or a disabling signal, Received by the controller 32, the enabling signal or the disabling signal will override the power supplying schedule to force the controller 32 to enable or disable the power supply of the power supplying interface 10.

The bypass signal generator 50 can be but not limited to a button type trigger to be triggered to generate the bypass signal. The bypass signal generator 50 connects to the controller 32. When the controller 32 receives the bypass signal generated by the bypass signal generator 50, the bypass signal overrides the current power supplying schedule and the controller 32 perform a switching action opposite to the current power supply status.

As shown in FIG. 1, the surge protection circuit 60 connects to the power supplying interface 10. When the power supplying interface 10 receives a voltage or current higher than a surge threshold, the surge protection circuit 60 performs surge protection, so as to prevent the smart cloud service power outlet 100 or the electric accessory connected thereto from being damaged by the surge.

The surge protection circuit 60 can be a circuit breaker, which breaks the circuit loop when receiving the surge; or the surge protection circuit 60 can be an optional grounding device. For example, a Zener diode connected to a grounding line; when the voltage or the surge is higher than the breakdown voltage, the Zener diode bypasses the large current to the grounding line. The smart cloud service power outlet 100 further includes a surge status indicator 62 connected to the controller 32. When the surge protection circuit 60 performs surge protection, the controller 32 drives the surge status indicator 62 to indicate surge protection event, for the user to determine wherein to cut off power manually. The surge protection event can be uploaded to the cloud service platform 200 via the wireless transceiver module 36, so as to be send to the designated e-mail address through e-mail; or pushed to the remote end device 300.

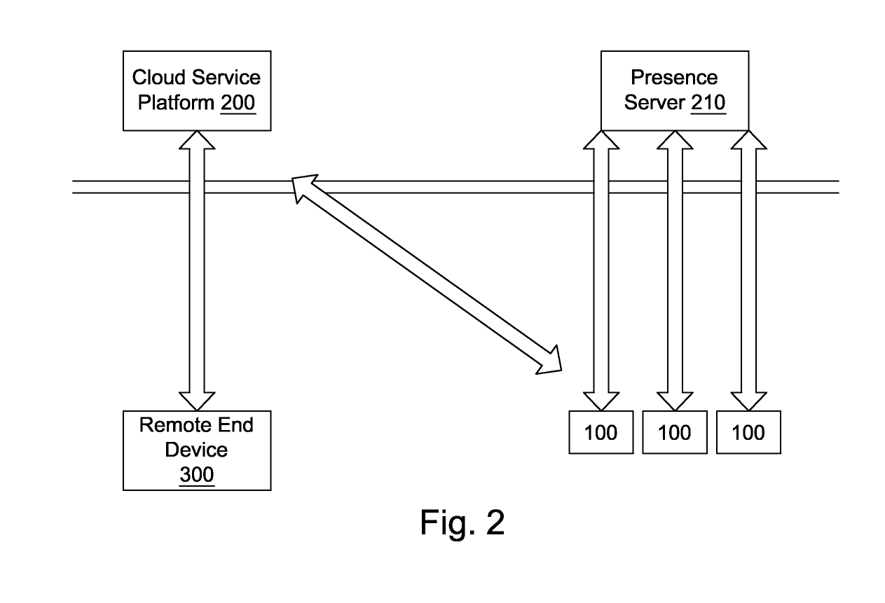

Please refer to FIG. 2, which shows a cloud service power consumption monitoring system according to this disclosure.

When the smart cloud service power outlet 100 is activated and connects to the WAN via the wireless transceiver module, the smart cloud service power outlet 100 establishes connection with a presence server 210. The presence server 210 continuously or periodically syncs with the smart cloud service power outlet 100, such as issuing Heat Beat, such that the online status monitoring server 210 determines whether the smart cloud service power outlet 100 is connected to the WAN according to the sync request; The smart cloud service power outlet 100 only establishes connection with the cloud service platform 200 under the following the circumstance, uploading power consumption results or downloading the power supplying schedule.

The cloud service platform includes a web server, used to transform the data uploaded by the smart cloud service power outlet 100 into web contents. When the remote end device 300 requires to accesses data of power consumption, the remote end device 300 connects to the cloud service platform 200 according to HTTP protocol and process the web contents. When the remote end device 300 connects to the cloud service platform 200 via the web browser, the cloud service platform 200 obtains the online status of the smart cloud service power outlet 100 via the presence server 210. If the smart cloud service power outlet 100 is online, the cloud service platform 200 establishes direct connection with the smart cloud service power outlet 100, and obtains the current and buffered power consumption results. And the cloud service platform 200 transforms accessed data into web contents to be loaded by the web browser of the remote end device 300. No matter whether the smart cloud service power outlet 100 is online or not, the cloud service platform 200 transforms the previously stored power consumption results into a power consumption log, and transforms this power consumption log into web contents to be loaded by the remote end device 300.

Instead of detecting online status of the smart cloud service power outlet 100 by cloud service platform 200 adopting HTTP protocols; this disclosure adopts the presence server 210 syncing with the smart cloud service power outlet 100. By such an approach, unnecessary data package transmission between the cloud service platform 200 and the cloud service power outlet 100 is reduced and the bandwidth speed of the cloud service platform 200 is improved. Capacity of management of the cloud service platform is increased without limited to 65535 ports.

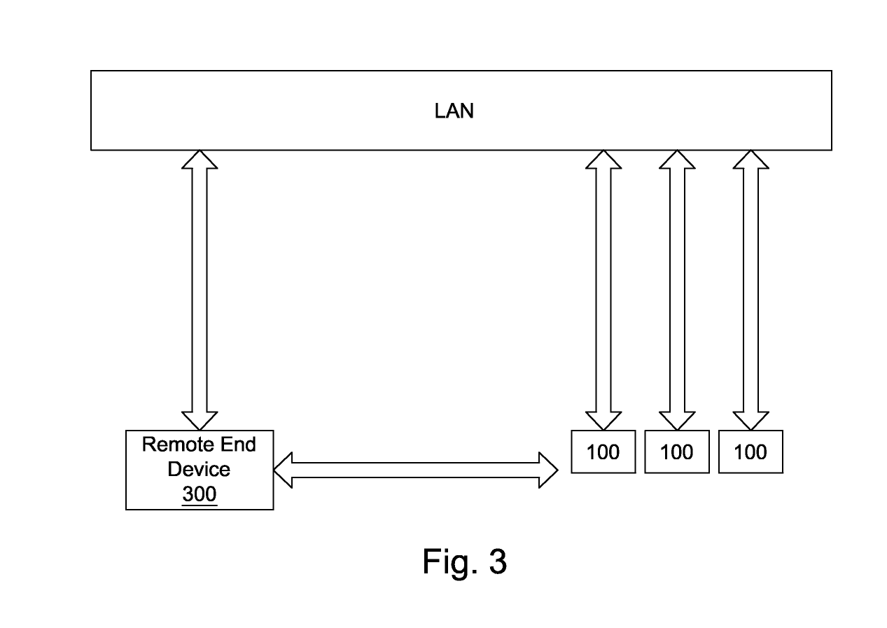

Please refer to FIG. 3, the smart cloud service power outlet 100 continuously or periodically broadcasts UDP data by UPNP component, and the smart cloud service power outlet 100 also provides HTTP service, so as to receive requests and provide data via CGI/HTML protocol.

The remote end device 300 also has UPNP component for retrieving broadcasted UDP data. When the remote end device 300 and the smart cloud service power outlet 100 are in the same LAN, for example both connecting to same wireless gateway, the remote end device 300 can receive the UDP data of the smart cloud service power outlet 100, so as to find out the smart cloud power outlet 100 which can be controlled by the remote end 300, and then the remote end device 300 establishes direct connection with the smart cloud service power outlet 100 within the LAN.

Through the HTTP service of the smart cloud service power outlet 100, The remote end device 300 directly controls the hardware abstraction layer (HAL) of the smart cloud service power outlet 100, so as to directly access the power supplying status of the smart cloud service power outlet 100, control the switch 40, or modify the power supplying schedule.

In one or more example, the remote end device 300 includes wireless connection function. When the remote end device 300 is located within the Wi-Fi connection range, the remote end device 300 can execute a Wi-Fi scan program to scan Wi-Fi signal to locate nearby Wi-Fi source. Meanwhile, the smart cloud service power outlet 100 transmits designated ID and MAC data carried by Wi-Fi signal (or other wireless signal according to the other protocol) via the wireless transceiver module 36. Through identification mechanism of the Wi-Fi scan program, the remote end device 300 picks up the Wi-Fi signal of the smart cloud service power outlet 100 according to the designated ID and MAC data, and then the remote end device 300 establishes peer-to-peer connection with the smart cloud service power outlet 100. Then, the remote end device 300 directly access the power supplying status of the smart cloud service power outlet 100, control the switch 40, or modify the power supplying schedule.

Through the power supplying schedule, the smart cloud service power outlet 100 enables and disables power supply, so as to manage electric power usage. The power supplying schedule includes power supplying plan for plural days, for example power supplying plan for a week. When the network connection fails for long time, a complete power supplying schedule for long term can be well executed before network connection is recovered.

Furthermore, through the bypass signal generator 50, the user can manually change the power supply status without restriction of the power supplying schedule.

In this disclosure, the presence of the smart cloud service power outlet 100 is detected via the presence server 210, so as to prevent unnecessary data package transmission between the cloud service platform 200 and the cloud service power outlet 100. Therefore, the bandwidth speed of the cloud service platform 200 is improved, and capacity of management of the cloud service platform 200 is increased.

What is claimed is:

1. A smart cloud service power outlet with surge protection, establishing communication with a cloud service platform via a wide-area-network, comprising:
a power supplying interface, connecting to an external power source and equipped with power output nodes;
a power consumption detector, connecting to the power supplying interface and the external power source, for detecting power consumption of the power supplying interface and generating a power consumption result;
a control system, including
a controller, connecting to the power consumption detector to receive the power consumption result, so as to monitor the power usage status of the power supplying interface;
a storage unit, storing a power supplying schedule and the power consumption result; wherein the controller enables or disables the power supply of the power supplying interface according to the power supplying schedule, and the power supplying schedule includes power supplying plan for plural days; and
a wireless transceiver module, connecting to a wireless bridging device through a local-area-network protocol, so as to connect to the wide-area-network; wherein the wireless transceiver module establishes connection to the cloud service platform to download the power supplying schedule to the storage unit and upload power consumption result to the cloud service platform, so as to generate a power consumption log;
a switch, disposed between the power supplying interface and the external power source; wherein the switch is controlled by the controller and the controller controls the power supplying interface to break or recover the connection between the power supplying interface and the external power source, so as to enable or disable the power supply of the power supplying interface; and
a bypass signal generator, used to be triggered to generate a bypass signal; when the controller receives the bypass signal, the bypass signal override the current power supplying schedule and the controller performs a switching action opposite to the current power supply status.

2. The smart cloud service power outlet as claimed in claim 1, wherein the power supplying interface is an outlet for household which is connected by a plug.

3. The smart cloud service power outlet as claimed in claim 1, further comprising a surge protection circuit, when the power supplying interface receives a voltage or current higher than a surge threshold, the surge protection circuit performs surge protection.

4. The smart cloud service power outlet as claimed in claim 1, wherein the control system includes a power loading threshold, the controller monitors the power loading of the power supplying interface via the power consumption detector; when the power loading of the power supplying interface is higher than the power loading threshold, the controller drives the switch to disables the power supply of the power supplying interface.

5. The smart cloud service power outlet as claimed in claim 4, wherein the controller the overloading event that the power loading is higher than the power loading threshold to the cloud service platform by the wireless transceiver module.

6. The smart cloud service power outlet as claimed in claim 1, further comprising a leakage current detecting circuit, for detecting leakage of the power supplying interface; when the controller obtains leakage event through the leakage current detecting circuit, the controller drives the switch to disables the power supply of the power supplying interface.

7. The smart cloud service power outlet as claimed in claim 1, wherein the controller transmits a device ID, for the cloud service platform to identify the smart cloud service power outlet.

8. The smart cloud service power outlet as claimed in claim 7, further comprising a remote end device, connects to the cloud service platform via the wide-area-network, to access the current power consumption result and the power consumption result history according to the device ID.

9. The smart cloud service power outlet as claimed in claim 8, wherein the remote end device issues an enabling signal or a disabling signal, and the enabling signal or the disabling signal overrides the current power supplying schedule to force the controller to enable or disable the power supply of the power supplying interface.

10. A cloud service power consumption monitoring system, comprising:
a smart cloud service power outlet as claimed in claim 1; and
a presence server, continuously or periodically syncs with the smart cloud service power outlet, such that the presence server determines whether the smart cloud service power outlet is connected to the wide-area-network; wherein when uploading power consumption result or downloading the power supplying schedule, the smart cloud service power outlet sends connection request to the cloud service platform, so as to establish connection.
